(19) United States
(12) Patent Application Publication
(10) Pub. No.: US 2026/0199921 A1
(43) Pub. Date: Jul. 16, 2026

(54) ELECTRONIC ATOMIZATION APPARATUS

(71) Applicant: Shenzhen Moore Vaporization Health & Medical Technology Co, Ltd., Shenzhen (CN)

(72) Inventor: Ruilong ZHOU, Shenzhen (CN)

(73) Assignee: Shenzhen Moore Vaporization Health & Medical Technology Co, Ltd., Shenzhen (CN)

(21) Appl. No.: 19/565,875

(22) Filed: Mar. 13, 2026

Related U.S. Application Data
(63) Continuation of application No. PCT/CN2024/087894, filed on Apr. 16, 2024.

(30) Foreign Application Priority Data
Sep. 15, 2023 (CN) 202311197697.1

(51) Int. Cl. B05B 15/18; B05B 7/04

(52) U.S. Cl. CPC B05B 15/18; B05B 7/0416

(57) ABSTRACT

An electronic atomization apparatus includes a main unit, a liquid storage assembly, and a nozzle assembly. The nozzle assembly has a first snap and a second snap. The first snap is configured to rotate along a circumferential direction of the nozzle assembly to be engaged with the liquid storage assembly. The second snap is configured to rotate along the circumferential direction of the nozzle assembly to be engaged with the main unit.

### RELATED APPLICATIONS

This application is a continuation application of International application No. PCT/CN2024/087894, filed on April 16, 2024, which claims priority to Chinese Patent Application No. 202311197697.1, filed on September 15, 2023. The entire disclosure of the prior applications are hereby incorporated by reference.

### TECHNICAL FIELD

The present invention relates to the field of electronic atomization technologies, including to an electronic atomization apparatus.

### BACKGROUND

An electronic atomization apparatus generally includes a liquid storage assembly and a nozzle assembly. The liquid storage assembly is configured to store an atomizable substrate. The nozzle assembly is in communication with the liquid storage assembly, and is configured to atomize the atomizable substrate to form an aerosol and spray out the aerosol. However, in an existing nozzle assembly, a residual atomizable substrate usually exists inside the nozzle assembly. The residual atomizable substrate stays in a nozzle for a long time. In one aspect, the nozzle is caused to block. In another aspect, a microbe is easily bred, resulting in a problem such as deterioration of the atomizable substrate.

### SUMMARY

This disclosure provides an electronic atomization apparatus, which is intended to solve problems that a nozzle assembly of an existing electronic atomization apparatus is easily blocked, and a residual atomizable substrate in the nozzle assembly is easily to breed a microbe, resulting in deterioration of the atomizable substrate.

To solve the foregoing technical problems, a technical solution used in this disclosure is to provide an electronic atomization apparatus. The electronic atomization apparatus includes:

a main unit;

a liquid storage assembly, arranged in the main unit, and configured to store an atomizable substrate; and

a nozzle assembly, in communication with the liquid storage assembly, and configured to atomize the atomizable substrate to form an aerosol, where the nozzle assembly has a first snap and/or a second snap, the first snap is configured to rotate along a circumferential direction of the nozzle assembly to be engaged with the liquid storage assembly, and the second snap is configured to rotate along the circumferential direction of the nozzle assembly to be engaged with the main unit.

In an aspect, the nozzle assembly has the first snap, the liquid storage assembly has a third snap, and the first snap rotates along the circumferential direction of the nozzle assembly to a position of the third snap, and is engaged with the third snap.

In an aspect, the first snap has a first end portion and a second end portion that are opposite to each other along an extension direction thereof, the third snap has a third end portion and a fourth end portion that are opposite to each other along the extension direction thereof, and the first end portion rotates towards the third snap along the circumferential direction of the nozzle assembly into the third snap, and is engaged with the third snap along an axial direction of the main unit; and

one of the second end portion and the fourth end portion has a limiting block, and the limiting block is located in a rotation path of the first snap, and is configured to stop the first snap from continuing to rotate in a current rotation direction.

In an aspect, the limiting block is formed on the second end portion of the first snap, and is configured to abut against the third end portion of the third snap.

In an aspect, one of a side surface of the first snap facing the third snap and a side surface of the third snap facing the first snap has a bump, and the other surface has a groove, and the bump is embedded in the groove to fix a relative position between the first snap and the second snap along a circumferential direction of the liquid storage assembly.

In an aspect, the groove is provided in a position of the first snap close to the first end portion, and the bump is formed in a position of the third snap close to the fourth end portion.

In an aspect, the nozzle assembly further includes a base body, the first snap includes a nozzle connection portion and a flange portion, the nozzle connection portion is connected to the base body, and the flange portion is connected to a side surface of the nozzle connection portion, and is spaced apart from the base body; and

the liquid storage assembly includes a liquid storage housing, the third snap includes a liquid storage connection portion and an engagement portion, the liquid storage connection portion is connected to the liquid storage housing, the engagement portion is connected to an end of the liquid storage connection portion facing away from the liquid storage housing, extends along a direction perpendicular to an axial direction of the liquid storage housing, and defines a U-shaped groove with the engagement portion and the liquid storage housing, and the flange portion is rotated into the U-shaped groove to be engaged with the liquid storage assembly.

In an aspect, the limiting block and the groove are both formed on a side surface of the flange portion facing the base body.

In an aspect, the liquid storage assembly further has a liquid outlet, the nozzle assembly further has a liquid inlet, the first snap and the third snap are both in a shape of an arc, the first snap is arranged around the liquid inlet, and the third snap is arranged around the liquid outlet.

In an aspect, the nozzle assembly further has the second snap, the main unit has a fourth snap, and the second snap is rotated along the circumferential direction of the nozzle assembly to a position of the fourth snap, and is engaged with the fourth snap.

In an aspect, one of the main unit and the nozzle assembly has a ball and the other has a ball groove, and the ball is rotated along the circumferential direction of the nozzle assembly to a position of the ball groove, and is embedded in the ball groove, to fix a relative position between the main unit and the nozzle assembly.

In an aspect, the nozzle assembly has the liquid inlet, two second snaps are arranged, the two second snaps are arranged opposite to each other on two sides of the liquid inlet, one of the second snaps is arranged on a side surface of the first snap facing away from the liquid inlet, and a portion of the other second snap protrudes toward a direction facing away from the liquid inlet.

The examples of this disclosure have the following beneficial effects. Different from the prior art, in the electronic atomization apparatus provided in the examples of this disclosure, the first snap and/or the second snap are/is arranged on the nozzle assembly, so that the first snap is rotated along the circumferential direction of the nozzle assembly to be engaged with the liquid storage assembly, thereby implementing the detachable connection between the nozzle assembly and the liquid storage assembly. The second snap is rotated along the circumferential direction of the nozzle assembly to be engaged with the main unit, thereby implementing the detachable connection between the nozzle assembly and the main unit. In this way, replacement or periodic maintenance of the main unit, the nozzle assembly, and the liquid storage assembly are facilitated. In addition, when the residual atomizable substrate exists in the nozzle assembly, causing the nozzle to be blocked or the residual atomizable substrate to be degraded, only the nozzle assembly may be replaced or repaired, so as not to damage the liquid storage assembly and/or the main unit, thereby resolving the problems of blocking of the nozzle and degradation of the atomizable substrate caused by the residual atomizable substrate in the nozzle assembly. In addition, the first snap is aligned with a corresponding position of the liquid storage assembly through rotation, and the engagement between the first snap and the liquid storage assembly is implemented. The second snap is aligned with a corresponding position of the main unit, and the engagement between the second snap and the main unit is implemented. The first snap may be smoothly transited to an engagement position corresponding to the liquid storage assembly, or the second snap may be smoothly transited to an engagement position corresponding to the main unit. Compared with a solution in which a large external force needs to be used to directly engage the first snap of the nozzle assembly with the liquid storage assembly along an axial direction Y of the liquid storage assembly and the second snap engages with the main unit along an axial direction Y of the main unit, risks that the first snap, the second snap, and corresponding snap members on the liquid storage assembly and the main unit are damaged during engagement are reduced. In addition, compared with a threaded connection, a screwing path may be shortened, and quick mounting and replacement of the main unit, the nozzle assembly, and the liquid storage assembly may be implemented.

### BRIEF DESCRIPTION OF THE DRAWINGS

FIG. 1a is a schematic diagram of an overall structure of an electronic atomization apparatus according to an example of this disclosure;

FIG. 1b is a cross-sectional view of the electronic atomization apparatus shown in FIG. 1a taken along line A-A according to an example of this disclosure;

FIG. 2 is an enlarged view of a position M in FIG. 1b;

FIG. 3 is a schematic diagram of an overall structure of a nozzle assembly and a liquid storage assembly after being connected according to an example of this disclosure;

FIG. 4 is a cross-sectional view taken along line B-B in FIG. 3;

FIG. 5 is a schematic structural diagram of a nozzle assembly according to an example of this disclosure from a first perspective;

FIG. 6 is a cross-sectional view of the nozzle assembly shown in FIG. 5 taken along line C-C;

FIG. 7 is a schematic structural diagram of a liquid storage assembly according to an example of this disclosure;

FIG. 8 is a partial schematic diagram of a liquid storage assembly according to an example of this disclosure;

FIG. 9 is a partial schematic diagram of a main unit according to an example of this disclosure;

FIG. 10 is a partial schematic diagram before a nozzle assembly is completely connected to a main unit according to an example of this disclosure;

FIG. 11 is a partial schematic diagram before a nozzle assembly is completely connected to a main unit according to another example of this disclosure;

FIG. 12 and FIG. 13 are schematic diagrams of an assembly process of an electronic atomization apparatus;

FIG. 14 is a transverse cross-sectional view of the structure shown in FIG. 13 according to an example of this disclosure;

FIG. 15 is a transverse cross-sectional view of the electronic atomization apparatus shown in FIG. 1a; and

FIG. 16 is a transverse cross-sectional view of the structure shown in FIG. 13 according to another example of this disclosure.

### DESCRIPTIONS OF REFERENCE NUMERALS

1-Main unit; 11-Fourth snap; 12-Ball; 13-Electronic control system; 14-Air pump; 15-Air tube joint; 2-Liquid storage assembly; 21-Liquid outlet; 22-Liquid storage housing; 23-Seal member; 24-Fixing member; 25-Third snap; 25a-Liquid storage connection portion; 25b-Engagement portion; 25c-Bump; 26-U-shaped groove; 3-Nozzle assembly; 31-Liquid inlet; 32-First snap; 32a-Nozzle connection portion; 32b-Flange portion; m-First end portion; n-Second end portion; 32c-Limiting block; 32d-Groove; 33-Second snap; 34-Base body; p-Third end portion; q-Fourth end portion; 35-Nozzle; 36-Gas sealing assembly; 37-Liquid outlet sealing assembly; 38-Airway; 39-Gas interface; 40-Liquid channel; 41-Ball groove.

### DETAILED DESCRIPTION

Technical solutions in examples of this disclosure are clearly and completely described below with reference to accompanying drawings in the examples of this disclosure. Apparently, the described examples are merely some rather than all of the examples of this disclosure. Other embodiments obtained by a person of ordinary skill in the art based on the embodiments of this disclosure without creative efforts fall within the protection scope of this disclosure.

Terms "first", "second", and "third" in this disclosure are merely intended for a purpose of description, and shall not be understood as an indication or implication of relative importance or implicit indication of a quantity of indicated technical features. Therefore, features defining "first", "second", and "third" may explicitly or implicitly include at least one of the features. In the description of this disclosure, "a plurality of" means at least two, such as two or three, unless otherwise definitely and specifically defined. All directional indications (for example, up, down, left, right, front, back) in the examples of this disclosure are only used for explaining relative position relationships, movement situations, or the like between the various components in a specific posture (as shown in the accompanying drawings). If the specific posture changes, the directional indications change accordingly. In addition, terms "include", "have", and any variant thereof are intended to cover a non-exclusive inclusion. For example, a process, a method, a system, a product, or a device that includes a series of steps or units is not limited to the listed steps or units, and instead, further optionally includes a step or unit that is not listed, or further optionally includes another step or unit that is intrinsic to the process, the method, the product, or the device.

The "example" mentioned in the specification means that features, structures, or characteristics described with reference to the examples may be included in at least one example of this disclosure. The phrase appearing at various locations in this specification does not necessarily indicate a same example, and is not an independent or alternative example exclusive to another example. A person skilled in the art explicitly or implicitly understands that the examples described in the specification may be combined with other examples.

In the related art, if an atomizable substrate remains in a nozzle assembly of an electronic atomization apparatus, two problems are easily caused. First, the atomizable substrate solidifies when staying in the nozzle assembly for a long time, causing the nozzle assembly to be blocked and cannot be continuously used. Second, the remaining atomizable substrate in the nozzle assembly is in contact with the air for a long time, which is easy to breed a microbe. As a result, deterioration of the atomizable substrate caused by pollution of the microbe is caused, thereby resulting in problems such as odor or skin damage of a user when the user is in contact with the deteriorated atomizable substrate.

Based on this, the examples of this disclosure provide an electronic atomization apparatus. The nozzle assembly is detachably connected to the liquid storage assembly/or a main unit, to facilitate replacement or periodic maintenance of the nozzle assembly. In addition, when a residual atomizable substrate exists in the nozzle assembly, causing the nozzle to be blocked or the residual atomizable substrate to be degraded, only the nozzle assembly may be replaced or maintained, so as not to damage the liquid storage assembly and/or the main unit, thereby resolving the problems of blocking of the nozzle and degradation of the atomizable substrate caused by the residual atomizable substrate in the nozzle assembly.

This disclosure is described in detail below with reference to the accompanying drawings and examples.

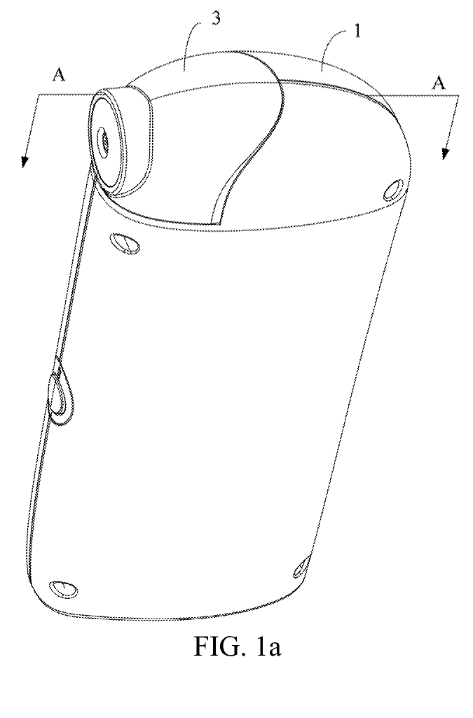

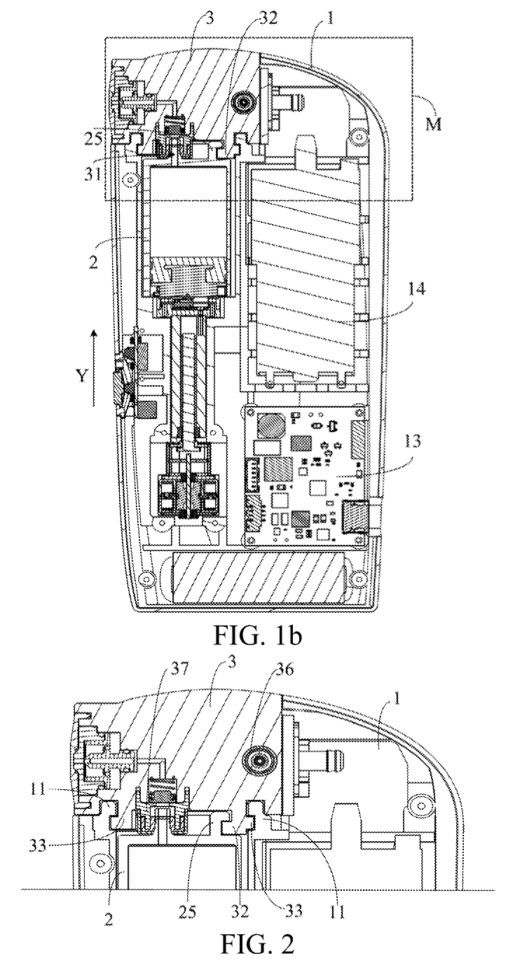

Referring to FIG. 1a to FIG. 2, FIG. 1a is a schematic diagram of an overall structure of an electronic atomization apparatus according to an example of this disclosure, FIG. 1b is a cross-sectional view of the electronic atomization apparatus shown in FIG. 1a taken along line A-A according to an example of this disclosure, and FIG. 2 is an enlarged view of a position M in FIG. 1b. In this example, an electronic atomization apparatus is provided, which is configured to atomize an atomizable substrate to form an aerosol. The electronic atomization apparatus may be specifically applied to technical fields such as medical treatment, cosmetics, health care, and electronic atomization. The atomizable substrate may use a liquid substrate, for example, an oil or a medicinal liquid added with an aroma component.

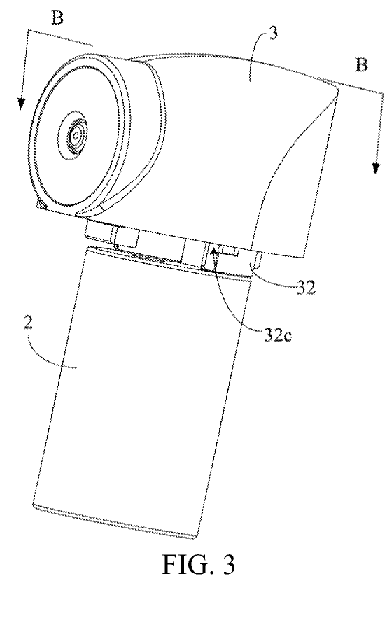

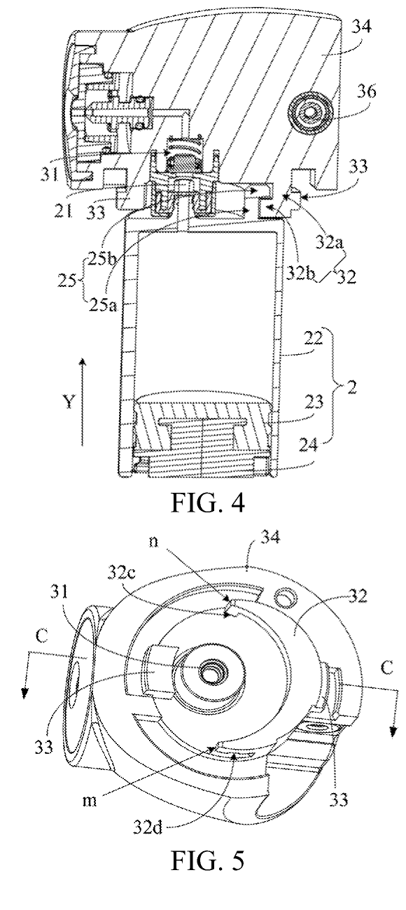

As shown in FIG. 1b, the electronic atomization apparatus includes a main unit 1, a liquid storage assembly 2, and a nozzle assembly 3. The liquid storage assembly 2 is arranged in the main unit 1, and has a liquid outlet 21 (refer to FIG. 4 below). The liquid storage assembly 2 is configured to store an atomizable substrate. Alternatively, the liquid storage assembly 2 stores an atomizable substrate, and the atomizable substrate flows out through the liquid outlet 21 of the liquid storage assembly 2. In an aspect, referring to FIG. 3 and FIG. 4, FIG. 3 is a schematic diagram of an overall structure of a nozzle assembly and a liquid storage assembly after being connected according to an example of this disclosure, and FIG. 4 is a cross-sectional view taken along line B-B in FIG. 3. The liquid storage assembly 2 includes a liquid storage housing 22, a seal member 23, and a fixing member 24. The liquid storage housing 22 is configured to form a liquid storage tank with the liquid outlet 21 on one end along an axial direction Y thereof. The seal member 23 and the fixing member 24 may be combined and made as one part, and are arranged on an other end of the liquid storage tank, to seal the atomizable substrate in the liquid storage tank. The atomizable substrate flows out of the liquid storage tank through the liquid outlet 21, or the atomizable substrate may be injected into the liquid storage tank through the liquid outlet 21. The seal member 23 and the fixing member 24 may be arranged in the liquid storage tank in an axially movable manner from an other end of the liquid storage tank, to implement active liquid supply of the liquid storage assembly 2. In this example, the main unit 1 includes a drive member. The drive member is connected to the fixing member 24 of the liquid storage assembly 2, and is configured to provide pushing force to push the fixing member 24 to move, for example, move toward the liquid outlet 21, so as to drive the atomizable substrate to flow out of the liquid storage tank through the liquid outlet 21. Certainly, the liquid storage assembly 2 may be passively provided with the liquid, that is, may be implemented through a siphon effect of a gas.

The nozzle assembly 3 has a liquid inlet 31. The liquid inlet 31 of the nozzle assembly 3 is in communication with the liquid storage assembly 2, and is configured to atomize the atomizable substrate to form the aerosol. The nozzle assembly 3 has a first snap 32 and/or a second snap 33. The first snap 32 is configured to rotate along a circumferential direction of the nozzle assembly 3 to be engaged with the liquid storage assembly 2, thereby implementing a detachable connection between the nozzle assembly 3 and the liquid storage assembly 2. After the first snap 32 is rotatably connected to the nozzle assembly 3, the liquid outlet 21 is in communication with the liquid inlet 31. The second snap 33 is configured to rotate along the circumferential direction of the nozzle assembly 3 to be engaged with the main unit 1, thereby implementing a detachable connection between the nozzle assembly 3 and the main unit 1. The nozzle assembly 3 is rotatably connected to the liquid storage assembly 2. It may be selected that the liquid storage assembly 2 does not move and the nozzle assembly 3 is rotated, or the nozzle assembly 3 does not move and the liquid storage assembly 2 is rotated, or the liquid storage assembly 2 and the nozzle assembly 3 are simultaneously rotated, and the two assemblies are rotated in opposite directions. This is not limited in this disclosure, provided that a rotational connection between the liquid storage assembly 2 and the nozzle assembly 3 is implemented. The nozzle assembly 3 is rotatably connected to the main unit 1 in a similar manner. The following examples of this disclosure all use the rotation of the nozzle assembly 3 as an example.

Based on the above, the nozzle assembly 3 is detachably connected to the liquid storage assembly 2/or the main unit 1, to facilitate replacement or periodic maintenance of the main unit 1, the nozzle assembly 3, and the liquid storage assembly 2. In addition, when a residual atomizable substrate exists in the nozzle assembly 3, causing the nozzle 35 to be blocked or the residual atomizable substrate to be degraded, only the nozzle assembly 3 may be replaced or maintained, so as not to damage the liquid storage assembly 2 and/or the main unit 1, thereby resolving the problems of blocking of the nozzle 35 and degradation of the atomizable substrate caused by the residual atomizable substrate in the nozzle assembly 3. In addition, the first snap 32 is aligned with a corresponding position of the liquid storage assembly 2 through rotation, and the engagement between the first snap and the liquid storage assembly is implemented. The second snap 33 is aligned with a corresponding position of the main unit 1, and the engagement between the second snap and the main unit is implemented. The first snap 32 may be smoothly transited to an engagement position corresponding to the liquid storage assembly 2, or the second snap 33 may be smoothly transited to an engagement position corresponding to the main unit 1. Compared with a solution in which a large external force needs to be used to directly engage the first snap 32 of the nozzle assembly 3 with the liquid storage assembly 2 along an axial direction Y of the liquid storage assembly 2 and the second snap 33 engages with the main unit 1 along an axial direction Y of the main unit 1, risks that the first snap 32, the second snap 33, and corresponding snap members on the liquid storage assembly 2 and the main unit 1 are damaged during engagement. In addition, compared with a threaded connection, a screwing path can be shortened, and quick mounting and replacement of the main unit 1, the nozzle assembly 3, and the liquid storage assembly 2 can be implemented.

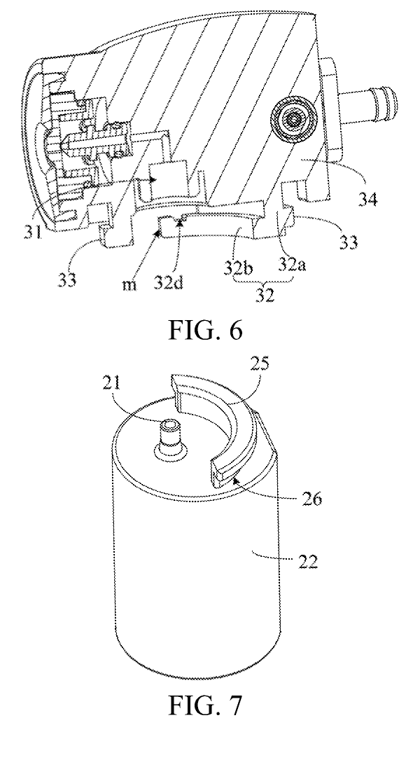

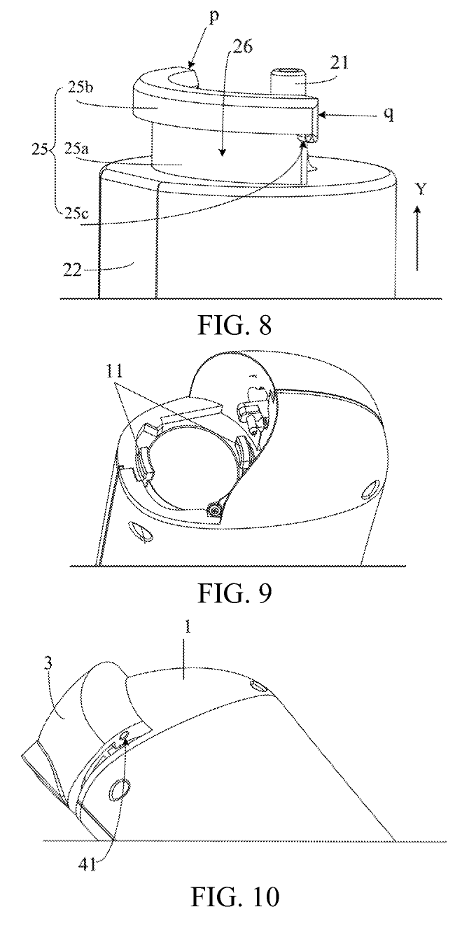

In an aspect, referring to FIG. 5 to FIG. 8, FIG. 5 is a schematic structural diagram of a nozzle assembly according to an aspect of this disclosure from a first perspective, FIG. 6 is a cross-sectional view of the nozzle assembly shown in FIG. 5 taken along line C-C, FIG. 7 is a schematic structural diagram of a liquid storage assembly according to an aspect of this disclosure, and FIG. 8 is a partial schematic diagram of a liquid storage assembly according to an aspect of this disclosure. The nozzle assembly 3 has the first snap 32. The liquid storage assembly 2 has a third snap 25. The first snap 32 rotates along the circumferential direction of the nozzle assembly 3 to a position of the third snap 25, and is engaged with the third snap 25.

As shown in FIG. 6, the nozzle assembly 3 further includes a base body 34. The first snap 32 includes a nozzle connection portion 32a and a flange portion 32b. The nozzle connection portion 32a is connected to the base body 34. The flange portion 32b is connected to a side surface of the nozzle connection portion 32a, and is spaced apart from the base body 34. The base body 34, the nozzle connection portion 32a, and the flange portion 32b may be specifically integrally formed.

As shown in FIG. 7 and FIG. 8, the third snap 25 includes a liquid storage connection portion 25a and an engagement portion 25b. The liquid storage connection portion 25a is connected to the liquid storage housing 22. The engagement portion 25b is connected to one end of the liquid storage connection portion 25a facing away from the liquid storage housing 22, extends along a direction perpendicular to an axial direction Y of the liquid storage housing 22, and defines a U-shaped groove 26 with the engagement portion 25b and the liquid storage housing 22. The flange portion 32b is rotated into the U-shaped groove 26 to be engaged with the liquid storage assembly 2.

In an aspect, with reference to FIG. 5 and FIG. 7, the first snap 32 and the third snap 25 are both in a shape of an arc, the first snap 32 is arranged around the liquid inlet 31 of the nozzle assembly 3, and the third snap 25 is arranged around the liquid outlet 21. In an example, the engagement portion 25b specifically extends along a circumferential direction of the liquid storage connection portion 25a, and protrudes from the liquid storage connection portion 25a in a direction facing away from the liquid outlet 21, so as to define a sliding groove extending around the liquid outlet 21 in the circumferential direction with the liquid storage housing 22 and the liquid storage connection portion 25a. It may be understood that the foregoing U-shaped groove 26 means that a vertical cross section of the sliding groove is U-shaped. The liquid storage housing 22 and the engagement portion 25b form two opposite side walls of the U-shaped groove 26. The liquid storage connection portion 25a forms a bottom wall of the U-shaped groove 26. After the first snap 32 is rotated into the U-shaped groove 26, the liquid storage housing 22 and the engagement portion 25b are engaged with the first snap 32 along the axial direction Y of the liquid storage housing 22, so as to implement a connection between the nozzle assembly 3 and the liquid storage assembly 2.

Specifically, the first snap 32 is formed on a side surface of the nozzle assembly 3 facing the liquid storage assembly 2. The third snap 25 is formed on a side surface of the liquid storage assembly 2 facing the nozzle assembly 3. In this way, it may be avoided that the first snap 32 and the third snap 25 damage another component of the electronic atomization apparatus or affect mounting of another component, and miniaturization production of the nozzle assembly 3 and the liquid storage assembly 2 are facilitated, so that the electronic atomization apparatus has a relatively beautiful overall appearance.

However, according to the foregoing arrangement, in a process in which the nozzle assembly 3 is rotatably connected to the liquid storage assembly 2, the user cannot clearly see a relative position between the first snap 32 and the third snap 25, that is, cannot learn whether the first snap 32 is exactly rotated to a position corresponding to the third snap 25. In this way, a problem that the first snap 32 and the third snap 25 are arranged in a staggered manner along the circumferential direction of the nozzle assembly 3 and the connection between the nozzle assembly 3 and the liquid storage assembly 2 is unstable easily occurs. In addition, the liquid outlet 21 and the liquid inlet 31 are arranged in a staggered manner, resulting in liquid leakage.

Therefore, in some examples, with reference to FIG. 5 to FIG. 7, the first snap 32 has a first end portion m and a second end portion n that are opposite to each other along the extension direction thereof. The third snap 25 has a third end portion p and a fourth end portion q that are opposite to each other along the extension direction thereof. The first end portion m of the first snap 32 is rotated towards the third snap 25 along the circumferential direction of the nozzle assembly 3, is screwed into the U-shaped groove 26 of the third snap 25, and is engaged and fixed to the third snap 25 along the axial direction Y of the main unit 1. One of the second end portion n and the fourth end portion q has a limiting block 32c, and the limiting block 32c is located in a rotation path of the first snap 32, and is configured to stop the first snap 32 from continuing to rotate in a current rotation direction.

In this way, in a process in which the nozzle assembly 3 and the liquid storage assembly 2 are engaged through rotation, a rotation angle of the nozzle assembly 3 along a preset direction may be limited through the limiting block 32c, thereby avoiding a case in which the rotation of the first snap 32 is stopped when the first snap is not completely screwed into the third snap 25 because the rotation angle is excessively small. In addition, a problem of unstable connection between the nozzle assembly 3 and the liquid storage assembly 2 or leakage caused by the staggered arrangement of the liquid outlet 21 and the liquid inlet 31 is avoided after the first snap 32 is screwed into the U-shaped groove 26 of the third snap 25 and continues to rotate and is staggered from the third snap 25 due to an excessively large rotation angle.

In an aspect, as shown in FIG. 5, a limiting block 32c is specifically formed on the second end portion n of the first snap 32, and the limiting block 32c is configured to abut against the third end portion p of the third snap 25, to stop the first snap 32 from continuing to rotate in the current rotation direction. Specifically, with reference to FIG. 5, the limiting block 32c is formed on a side surface of the flange portion 32b facing the base body 34.

Certainly, in another example, the limiting block 32c may also be formed on the fourth end portion q of the third snap 25, and protrudes toward the U-shaped groove 26, to be located in the rotation path of the first snap 32, and stop the first snap 32 from continuing to rotate in the current rotation direction.

To prevent the first snap 32 from being rotated in an opposite direction after the first snap 32 and the third snap 25 are engaged, which causes the first snap to be staggered from the third snap 25 or even disengaged from the third snap 25, resulting in a case in which the nozzle assembly 3 disengages from the liquid storage assembly 2, in an example, referring to FIG. 6 and FIG. 8, one of a side surface of the first snap 32 facing the third snap 25 and a side surface of the third snap 25 facing the first snap 32 has a bump 25c, and the other surface has a groove 32d, and the bump 25c is embedded in the groove 32d to fix a relative position between the first snap 32 and the second snap 33 along a circumferential direction of the liquid storage assembly 2.

Specifically, as shown in FIG. 6, the groove 32d is provided in a position of the first snap 32 close to the first end portion m. Specifically, the groove 32d is formed on a side surface of the flange portion 32b facing the base body 34. As shown in FIG. 8, the bump 25c is formed on a position of the third snap 25 close to the fourth end portion q.

In a process in which the nozzle assembly 3 is rotatably connected to the liquid storage assembly 2, the liquid outlet 21 of the liquid storage assembly 2 is first inserted into the liquid inlet 31 of the nozzle assembly 3, and then rotated clockwise, so that the first snap 32 is aligned and fixed with the third snap 25, and limitation is performed through the limiting block 32c. If the nozzle assembly 3 or the liquid storage assembly 2 needs to be replaced or inspected, rotation may be performed in an opposite direction.

In an example, with reference to FIG. 5, FIG. 6, and FIG. 9, FIG. 9 is a partial schematic diagram of a main unit according to an example of this disclosure. The nozzle assembly 3 further has a second snap 33. The main unit 1 has a fourth snap 11. The second snap 33 rotates along a circumferential direction of the nozzle assembly 3 to a position of the fourth snap 11, and is engaged with the fourth snap 11.

Specifically, as shown in FIG. 5 or FIG. 6, two second snaps 33 are arranged. The two second snaps 33 are arranged opposite to each other on two sides of the liquid inlet 31, one of the second snaps 33 is arranged on a side surface of the first snap 32 facing away from the liquid inlet 31, and a portion of the other second snap 33 protrudes toward a direction facing away from the liquid inlet 31. In this example, two fourth snaps 11 are also provided. The two fourth snaps 11 are arranged in one-to-one correspondence with the two second snaps 33. In addition, the fourth snap 11 defines a groove, and the second snap 33 is rotated into the groove, to limit a relative position between the nozzle assembly 3 and the main unit 1 along the axial direction Y of the main unit 1.

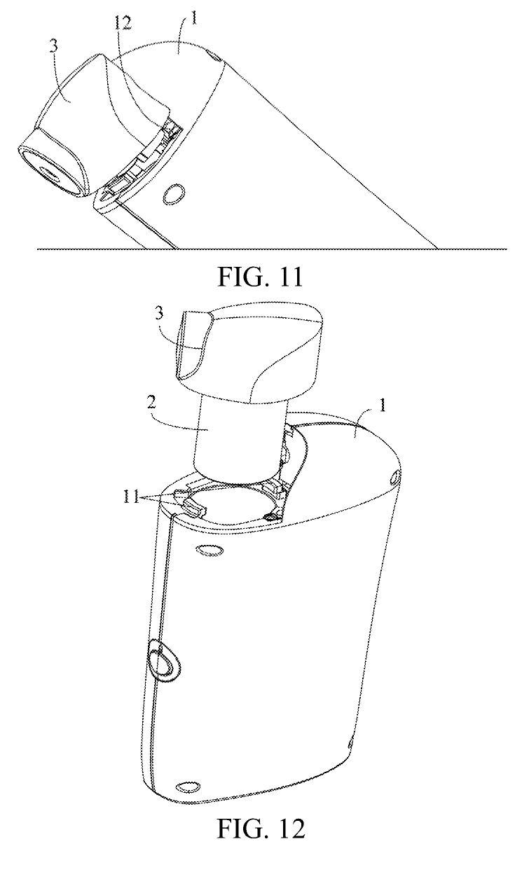

To prevent the second snap 33 and the fourth snap 11 from being relatively displaced after the second snap 33 is rotatably connected to the fourth snap 11, resulting in a case in which the nozzle assembly 3 and the liquid storage assembly 2 to disengage from the main unit 1, in an example, referring to FIG. 10 and FIG. 11, FIG. 10 is a partial schematic diagram before a nozzle assembly is completely connected to a main unit according to an example of this disclosure, and FIG. 11 is a partial schematic diagram before a nozzle assembly is completely connected to a main unit according to another example of this disclosure. One of the main unit 1 and the nozzle assembly 3 has a ball 12 and the other has a ball groove 41, and the ball 12 is rotated along the circumferential direction of the nozzle assembly 3 to a position of the ball groove 41, and is embedded in the ball groove 41, to fix a relative position between the main unit 1 and the nozzle assembly 3. It may be understood that the ball 12 is rotated into position when being embedded in the ball groove 41, and does not need to be continuously rotated.

Specifically, as shown in FIG. 10, the ball groove 41 is formed on a side surface facing the main unit 1 of the nozzle assembly 3. As shown in FIG. 11, the ball 12 is formed on a side surface of the main unit 1 facing the nozzle assembly 3.

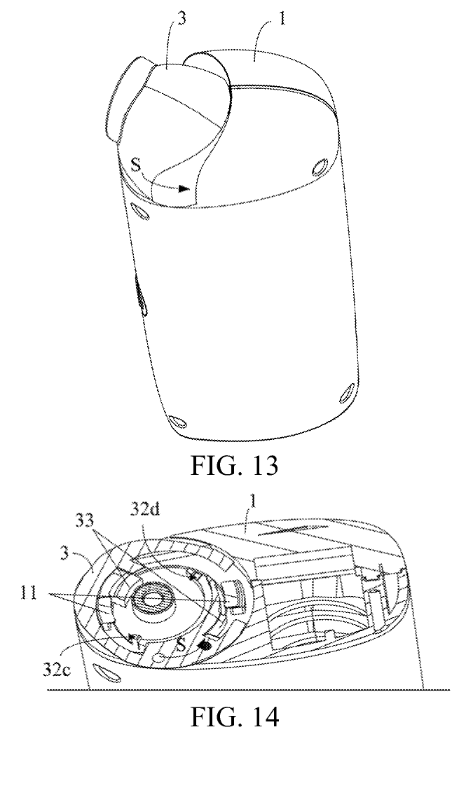

Referring to FIG. 12 to FIG. 14, FIG. 12 and FIG. 13 are schematic diagrams of an assembly process of an electronic atomization apparatus, and FIG. 14 is a transverse cross-sectional view of the structure shown in FIG. 13 according to an example of this disclosure. In a specific assembly process, as shown in FIG. 12, the nozzle assembly 3 is first rotatably connected to the liquid storage assembly 2. Then, as shown in FIG. 13, the nozzle assembly 3 and the liquid storage assembly 2 are inserted into the main unit 1 at a preset angle, so that the second snap 33 and the fourth snap 11 are staggered. In this way, the second snap 33 is facilitated to be rotatably connected to the fourth snap 11. A specific size of the preset angle may be determined according to an actual design. For the relative position between the second snap 33 and the fourth snap 11 after the nozzle assembly 3 is inserted into the main unit 1 at the preset angle, reference may be made to FIG. 14. Then, as shown in FIG. 14, the nozzle assembly 3 is rotated in the preset direction S, so that the second snap 33 and the fourth snap 11 are aligned along the axial direction Y of the main unit 1, and the ball 12 is embedded in the ball groove 41, thereby implementing a rotational connection between the nozzle assembly 3 and the main unit 1. For a structure after the nozzle assembly 3 is connected to the main unit 1, reference may be made to FIG. 1a.

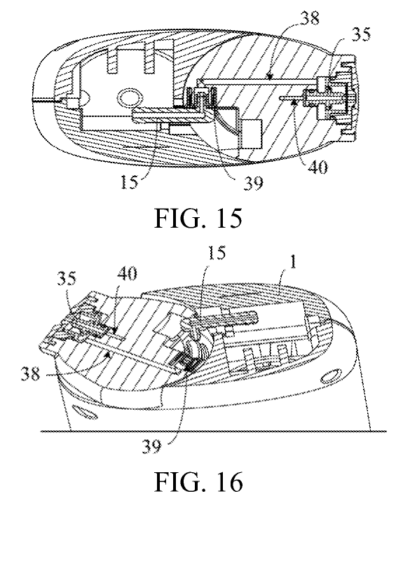

In an aspect, as shown in FIG. 1b, FIG. 2, and FIG. 15, FIG. 15 is a transverse cross-sectional view of an electronic atomization apparatus shown in FIG. 1a. The main unit 1 further includes an electronic control system 13, an air pump 14, and an air tube joint 15 that is in communication with the air pump 14 in sequence. The electronic control system 13 is configured to control the entire electronic atomization apparatus to operate normally. The air pump 14 is configured to provide a high-pressure gas. The nozzle assembly 3 further includes a nozzle 35, a gas sealing assembly 36, a liquid outlet sealing assembly 37, an airway 38, a gas interface 39, and a liquid channel 40. One end of the airway 38 is in communication with the nozzle 35, and an other end of the airway 38 is in communication with a gas interface 39. The gas interface 39 is configured to be communicatively connected to the air tube joint 15 of the main unit 1, and is configured to deliver the high-pressure gas provided by the air pump 14 to the nozzle 35. The liquid channel 40 forms the liquid inlet 31, and is separately in communication with the liquid inlet 31 and the nozzle 35 of the liquid storage assembly 2, to deliver an atomizable substrate in the liquid storage assembly 2 to the nozzle 35. The high-pressure gas sequentially passes from the air pump 14 through the air tube joint 15 and the gas interface 39, then enters the airway 38, and finally interacts with the atomizable substrate in the nozzle 35 in the nozzle 35 to form the aerosol. The gas sealing assembly 36 is configured to seal the airway 38. The liquid outlet sealing assembly 37 is configured to seal the liquid inlet.

As shown in FIG. 16, FIG. 16 is a transverse cross-sectional view of the structure shown in FIG. 13 according to another example of this disclosure. When the nozzle assembly 3 is inserted into the main unit 1 and is not rotated, the gas interface 39 is not connected to the air tube joint 15. After being rotated for a specific angle, when the second snap 33 is engaged with and fixed to the fourth snap 11, as shown in FIG. 15, the gas interface 39 is also rotated into the air tube joint 15 of the main unit 1, to supply gas to the nozzle 35.

According to the electronic atomization apparatus provided in the examples, the first snap 32 and/or the second snap 33 are/is arranged on the nozzle assembly 3, so that the first snap 32 is rotated along the circumferential direction of the nozzle assembly 3 to be engaged with the liquid storage assembly 2, thereby implementing the detachable connection between the nozzle assembly 3 and the liquid storage assembly 2. The second snap 33 is rotated along the circumferential direction of the nozzle assembly 3 to be engaged with the main unit 1, thereby implementing the detachable connection between the nozzle assembly 3 and the main unit 1. In this way, replacement or periodic maintenance of the main unit 1, the nozzle assembly 3, and the liquid storage assembly 2 is facilitated. In addition, when the residual atomizable substrate exists in the nozzle assembly 3, causing the nozzle 35 to be blocked or the residual atomizable substrate to be degraded, only the nozzle assembly 3 may be replaced or maintained without replacing the main unit 1 and/or the liquid storage assembly 2, so as not to damage the liquid storage assembly 2 and/or the main unit 1, thereby resolving the problems of blocking of the nozzle 35 and degradation of the atomizable substrate caused by the residual atomizable substrate in the nozzle assembly 3. In addition, the first snap 32 is aligned with a corresponding position of the liquid storage assembly 2 through rotation, and the engagement between the first snap and the liquid storage assembly is implemented. The second snap 33 is aligned with a corresponding position of the main unit 1, and the engagement between the second snap and the main unit is implemented. The first snap 32 may be smoothly transited to an engagement position corresponding to the liquid storage assembly 2, or the second snap 33 may be smoothly transited to an engagement position corresponding to the main unit 1. Compared with a solution in which a large external force needs to be used to directly engage the first snap 32 of the nozzle assembly 3 with the liquid storage assembly 2 along an axial direction Y of the liquid storage assembly 2 and the second snap 33 engages with the main unit 1 along an axial direction Y of the main unit 1, risks that the first snap 32, the second snap 33, and corresponding snap members on the liquid storage assembly 2 and the main unit 1 are damaged during engagement. In addition, compared with a threaded connection, a screwing path can be shortened, and quick mounting and replacement of the main unit 1, the nozzle assembly 3, and the liquid storage assembly 2 can be implemented.

The foregoing descriptions are merely implementations of this disclosure, and the patent scope of this disclosure is not limited thereto. All equivalent structure or equivalent process changes made according to the content of this specification and accompanying drawings in this disclosure or by directly or indirectly applying this disclosure in other related technical fields shall fall within the protection scope of this disclosure.

What is claimed is:

1. An electronic atomization apparatus comprising:
a main unit;
a liquid storage assembly, in the main unit, storing an atomizable substrate; and
a nozzle assembly being configured to atomize the atomizable substrate to form an aerosol, the nozzle assembly including a first snap and a second snap, wherein
the first snap is configured to rotate along a circumferential direction which the nozzle assembly to be engaged with the liquid storage assembly, and
the second snap is configured to rotate along the circumferential direction which the nozzle assembly to be engaged with the main unit.

2. The electronic atomization apparatus of claim 1,
the liquid storage assembly further comprising a third snap, and the first snap rotates along the circumferential direction to a position of the third snap, and is engaged with the third snap.

3. The electronic atomization apparatus of claim 2, wherein
the first snap includes a first end portion and a second end portion that are opposite to each other,
the third snap includes a third end portion and a fourth end portion that are opposite to each other, and
the first end portion rotates toward the third snap along the circumferential direction into the third snap, and is engaged with the third snap along an axial direction of the main unit; and
a limiting block is located at the second end portion or the fourth end portion, and the limiting block is in a rotation path of the first snap to stop the first snap for further rotation.

4. The electronic atomization apparatus of claim 3, wherein
the limiting block is formed on the second end portion of the first snap, and is configured to abut against the third end portion of the third snap.

5. The electronic atomization apparatus of claim 3, wherein
one of a side surface of the first snap facing the third snap and
a side surface of the third snap facing the first snap has a bump and another
surface has a groove, and the bump is embedded in the groove to fix a relative position between the first snap and the second snap along a circumferential direction of the liquid storage assembly.

6. The electronic atomization apparatus of claim 5, wherein
the groove is provided in a position of the first snap close to the first end portion, and the bump is formed in a position of the third snap close to the fourth end portion.

7. The electronic atomization apparatus of claim 6, the nozzle assembly further comprising:
a base body, the first snap comprises a nozzle connection portion and a flange portion, the nozzle connection portion is connected to the base body, and the flange portion is connected to a side surface of the nozzle connection portion, and is spaced apart from the base body.

8. The electronic atomization apparatus of claim 7, liquid storage assembly further comprising:
a liquid storage housing,
the third snap comprises a liquid storage connection portion and an engagement portion,
the liquid storage connection portion is connected to the liquid storage housing,
the engagement portion is connected to an end of the liquid storage connection portion facing away from the liquid storage housing, extends along a direction perpendicular to an axial direction of the liquid storage housing, and defines a U-shaped groove with the engagement portion and the liquid storage housing, and
the flange portion is rotated into the U-shaped groove to be engaged with the liquid storage assembly.

9. The electronic atomization apparatus of claim 8, wherein
the limiting block and the groove are both formed on a side surface of the flange portion facing the base body.

10. The electronic atomization apparatus of claim 2, wherein
the liquid storage assembly further includes a liquid outlet,
the nozzle assembly further includes a liquid inlet, the first snap and the third snap are both in a shape of an arc, the first snap is arranged around the liquid inlet, and the third snap is arranged around the liquid outlet.

11. The electronic atomization apparatus of claim 1, wherein
the nozzle assembly further includes the second snap, the main unit includes a fourth snap, and the second snap is rotated along the circumferential direction of the nozzle assembly to a position of the fourth snap, and is engaged with the fourth snap.

12. The electronic atomization apparatus of claim 11, further comprising:
a ball and a ball groove being located in the main unit and the nozzle assembly respectively, and
the ball being rotated along the circumferential direction of the nozzle assembly to a position of the ball groove to fix a relative position between the main unit and the nozzle assembly.

13. The electronic atomization apparatus of claim 11, wherein
the nozzle assembly includes the liquid inlet and two second snaps,
the two second snaps are arranged opposite to each other on two sides of the liquid inlet, one of the second snaps is arranged on a side surface of the first snap facing away from the liquid inlet, and a portion of another second snap protrudes toward a direction facing away from the liquid inlet.
